(19) United States
(12) Patent Application Publication
(10) Pub. No.: US 2006/0074937 A1
(43) Pub. Date: Apr. 6, 2006

(54) Apparatus and method for client-side routing of database requests

(75) Inventors: Paul Miller Bird, Markham (CA); Albert Joseph Bockhold, Rochester, MN (US); William T. Newport, Rochester, MN (US); John Joseph Stecher, Rochester, MN (US); Timothy Jon Vincent, Toronto (CA)

Correspondence Address: MARTIN & ASSOCIATES, LLC, P.O. BOX 548, CARTHAGE, MO, 64836-0548, US

(73) Assignee: INTERNATIONAL BUSINESS MACHINES CORPORATION, ARMONK, NY (US)

(21) Appl. No.: 10/956,534

(22) Filed: Sep. 30, 2004

(51) Int. Cl. G06F 7/00

(52) U.S. Cl. 707/100

(57) ABSTRACT

An apparatus and method provide client-side routing of database requests to enhance the performance of a partitioned database system. In a first embodiment, the database client determines the correct database server for a transaction, and routes requests for the transaction to the correct database server. In a second embodiment, the database client sends a first database request in a transaction to a selected database server, determines from the response the correct database server, and routes all subsequent requests for the transaction to the correct database server. In a third embodiment, the database client sends a first database request in a transaction to a selected database server, which routes the first request to the correct database server, which returns the results directly to the database client via direct connection. The database client then routes all subsequent database requests in the transaction directly to the correct database server.

### BACKGROUND OF THE INVENTION

1. Technical Field

This invention generally relates to computer systems and more specifically relates to database apparatus and methods.

2. Background Art

Many modern computer systems are a complex combination of different hardware and software that are interconnected on a network. Networks allow computers to share information. Shared information may be stored in a central database.

A modern development is to divide a database into multiple partitions, and to have a database server that is dedicated to servicing one of the database partitions. Thus, a database that has four partitions will include four database servers, one per partition. In the prior art, when multiple database servers are present, an application server selects one of the database servers, and sends all database requests to that selected database server. If a database request should be handled by the selected database server, the selected database server processes the database request and returns the results of the database request. If a database request should be handled by a different database server, the selected database server routes the database request to the correct database server, which returns the results to the selected database server, which, in turn, returns the results to the application server. As the number of partitions, and hence database servers, increases, the likelihood that the selected server is the correct server to process the database request goes down. The routing of database requests to other database servers, and the routing of the results back to the selected database server, then to the application server, creates overhead that results in significant performance penalties. Without a way to reduce the amount of redirection of database requests and results, the computer industry will continue to suffer from inefficient methods for processing database requests in a partitioned database system.

### DISCLOSURE OF INVENTION

According to the preferred embodiments, an apparatus and method provide client-side routing of database requests to enhance the performance of a partitioned database system. In a first embodiment, the database client determines from a map of the database the correct server to handle a transaction, and submits all database requests in the transaction directly to the correct server, which returns the results directly to the database client. In a second embodiment, the database client submits a database request to a selected database server. If the selected database server is the correct database server for the database request, the selected database server processes the request and returns the results to the database client. If the selected database server is not the correct server for the database request, the selected database server returns a code to the database client indicating the correct database server for the transaction. The database client then submits all the database requests for the transaction directly to the correct database server, and receives the results directly from the correct database server. In a third embodiment, the database client opens connections to all database servers, which also have connections between themselves. The database client submits a database request to a selected database server. If the selected database server is the correct database server for the database request, the selected database server processes the database request and returns the results to the database client. If the selected database server is not the correct server for the database request, the selected database server routes the database request to the correct database server, which sends the results to the database client via its direct connection to the database client. In all three embodiments, the database client may inform an application server regarding which database server to enlist for a transaction. This enlistment provides for transaction recovery according to methods known in the art.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a block diagram of a prior art partitioned database system;

FIG. 3 is a prior art method for the partitioned database system shown in FIG. 2;

FIG. 4 is a block diagram of a partitioned database system in accordance with first and second embodiments;

FIG. 5 is a flow diagram of a method in accordance with the first and second embodiments for the system shown in FIG. 4;

FIG. 6 is a flow diagram of a method in accordance with the first, second and third embodiments for client-directed enlistment of a database server by an application server;

FIG. 7 is a flow diagram of a method in accordance with the second embodiment for the system shown in FIG. 4;

FIG. 8 is a block diagram of a partitioned database system in accordance with a third embodiment; and

FIG. 9 is a flow diagram of a method in accordance with the third embodiment for the system shown in FIG. 8.

### BEST MODE FOR CARRYING OUT THE INVENTION

The preferred embodiments allow client-side routing of database requests to improve system performance in a partitioned database system. The database client determines the correct server, then routes database requests in a transaction to the correct server. By directly communicating with the correct server, the performance of the database client is substantially improved.

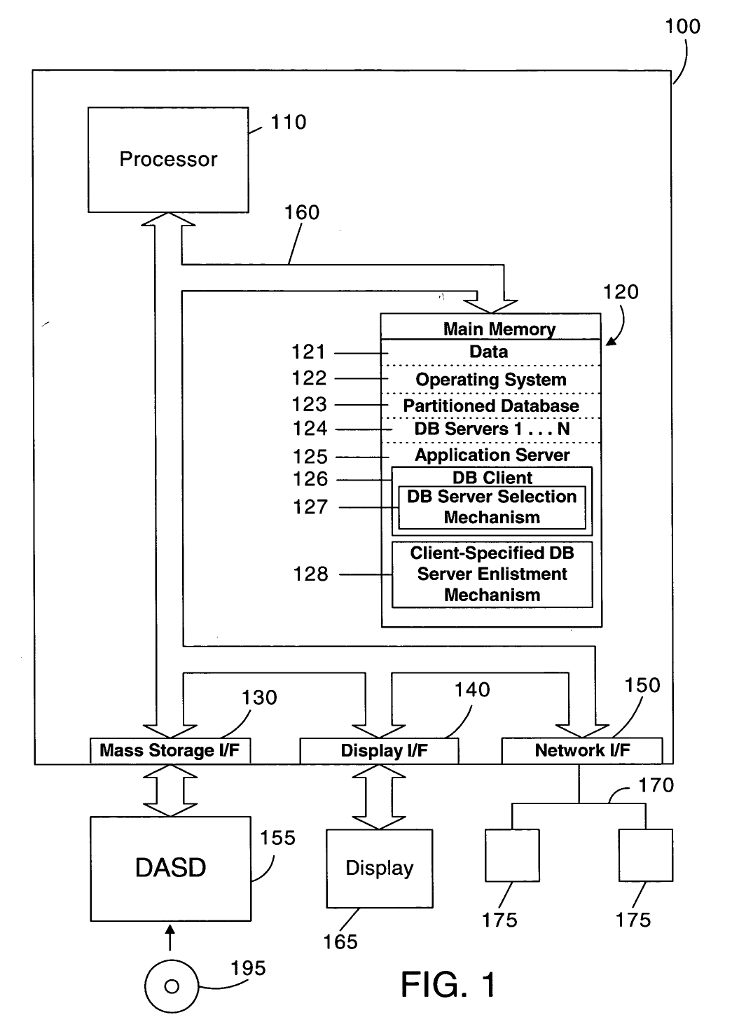

Referring now to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices (such as a direct access storage device 155) to computer system 100. One specific type of direct access storage device 155 is a readable and writable CD RW drive, which may store data to and read data from a CD RW 195.

Main memory 120 in accordance with the preferred embodiments contains data 121, an operating system 122, a partitioned database 123, multiple database servers 124, and an application server 125. Data 121 represents any data that serves as input to or output from any program in computer system 100. Operating system 122 is a multitasking operating system known in the industry as OS/400; however, those skilled in the art will appreciate that the spirit and scope of the present invention is not limited to any one operating system. Partitioned database 123 is any suitable database, whether currently known or developed in the future, that is divided into multiple partitions. Database servers 124 process database requests for the partitioned database 123. In the most preferred implementation, there is one database server 124 for each database partition in partitioned database 123.

The application server 125 provides an interface for computer programs known as “applications” to access the partitioned database 123. The application server 125 includes a database client 126, which receives calls from applications that include database requests in the form of database statements, such as statements in Structured Query Language (SQL). The database client 126 includes a database server selection mechanism 127 that allows the database client 126 to determine the correct database server for a transaction, and to directly route database requests for the transaction to the correct database server. The application server 125 also includes a client-specified database server enlistment mechanism 128. In the prior art, at the beginning of a transaction, an application server enlists a database server, and all database requests and results are routed through the selected database server. In the application server 125 of the preferred embodiments, the database server selection mechanism 127 in the database client 126 determines the correct database server for the transaction, and directly routes database requests for the transaction to the correct database server. In addition, the database client specifies to the application server which database server should be enlisted for the transaction. Note, however, that the enlistment need not be performed before processing any database requests in the transaction. The enlistment simply needs to be done before the application server does transaction commit processing. In addition, the enlistment may be done asynchronously with respect to the database requests and results flowing between the database client 126 and the correct database server. The purpose of the enlistment is to provide for error-recovery of the transaction. The concepts of enlistment of database servers for the purpose of error recovery is well-known in the art, and is therefore not discussed in more detail here.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, partitioned database 123, database servers 124, and application server 125 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks and CD RW (e.g., 195 of FIG. 1), and transmission type media such as digital and analog communications links.

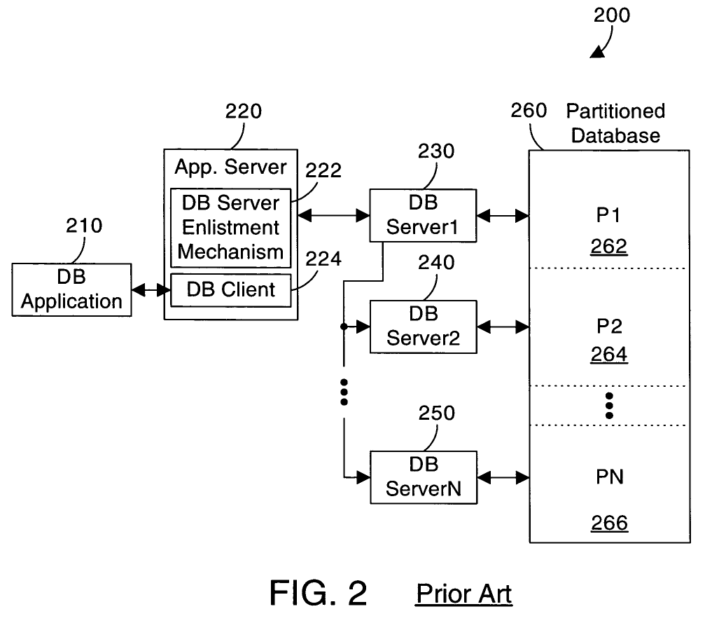

Referring to FIG. 2, a prior art database system 200 is presented to provide a context for presenting the principles of the preferred embodiments. Database system 200 includes a partitioned database 260 with multiple database partitions, shown in FIG. 2 as partition 1 (262), partition 2 (264), through partition N (266). Each database partition has a corresponding database server. Thus, database partition 262 has a corresponding database server 230; database partition 264 has a corresponding database server 240; and database partition 266 has a corresponding database server 250. Each database server is responsible for processing database statements that target the database server's corresponding partition. System 200 also includes an application server 220 that includes a database server enlistment mechanism 222 and a database client 224. The database server enlistment mechanism 222 is used by the application server 220 to “enlist” one of the database servers for a particular transaction. By enlisting a database server, the application server 220 provides for error recovery in the event that the transaction fails. The step of registering a database server causes information about the transaction and the corresponding database server to be stored that allow transaction recovery in the event of transaction failure.

The database client 224 in the application server 220 provides an interface for accessing the database 260. The database client 224 may thus be called to access the database 260. FIG. 2 shows a database application 210 as one suitable computer program that could access the database client 224.

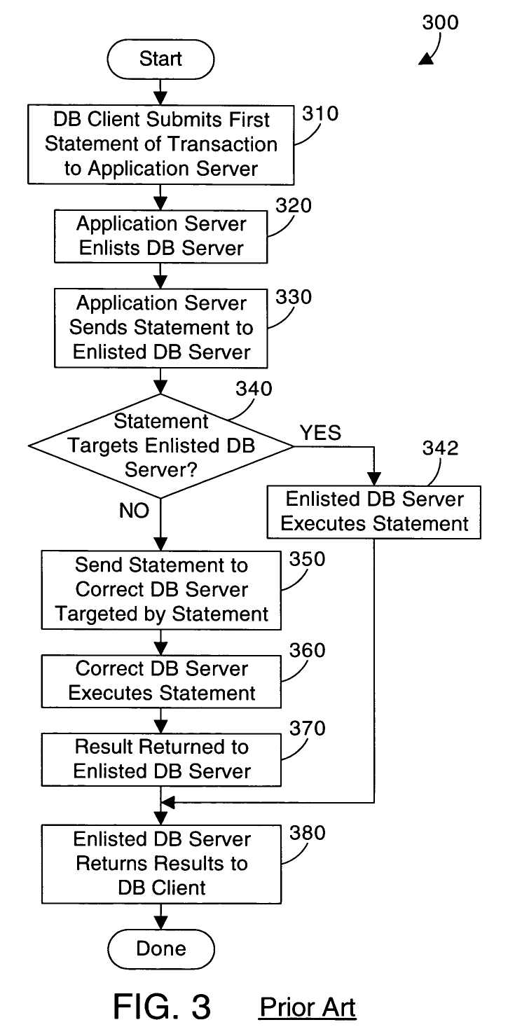

Referring now to FIG. 3, a prior art method 300 shows the steps that are performed in the prior art system 200 shown in FIG. 2. First, the database client receives a transaction (such as from the database application 210 in FIG. 2), and submits the first statement of the transaction to the application server (step 310). In response, the application server enlists one of the database servers (step 320). In the prior art, a default or “bootstrap” database server is designated, and the application server would then enlist the bootstrap database server in step 320. For the specific example in FIG. 2, we assume that database server 230 is the bootstrap database server, so we assume that the application server 220 enlists the database server 230 in step 320.

The application server then sends the first statement in the transaction that was received from the database client to the enlisted database server (step 330). If the first statement targets the enlisted database server (step 340=YES), the enlisted database server executes the statement (step 342). Note that a statement targets the enlisted database server if the statement accesses the database partition that corresponds to the enlisted database server. If the statement does not target the enlisted database server (step 340=NO), the enlisted database server sends the statement to the correct database server (step 350). The correct database server then executes the statement (step 360). The result is then returned from the correct database server to the enlisted database server (step 370). The enlisted database server then returns the results to the application server (step 380). The application server, in turn, returns the results to the database client (step 380). The database client may then return the results to the program that called the database client to execute the transaction.

The prior art method of handling database requests in a partitioned database system suffers from overhead that significantly and adversely affects system performance. Because all database statements are directed to a single database server, then routed to the correct server, this double-handling of database statements negatively impacts system performance. As the number of database servers grows, the likelihood that the enlisted bootstrap server can directly process the database statement goes down, which leads to additional overhead. In addition, providing a single bootstrap database server that routes all requests to the other database servers presents a single point of failure in the bootstrap database server. Should the bootstrap database server 230 fail, the entire partitioned database system 200 would fail. The combination of high overhead and single-point failure create a need for a new and improved system for accessing a partitioned database.

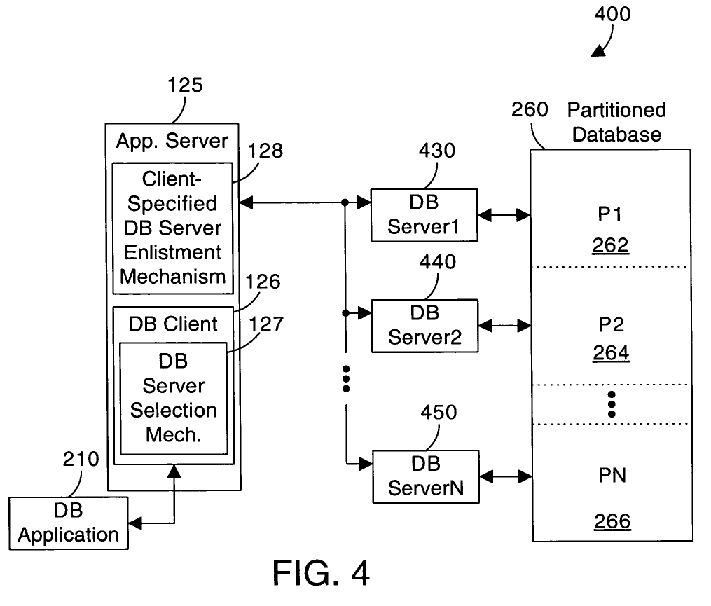

Referring now to FIG. 4, a partitioned database system 400 in accordance with the preferred embodiments includes the same partitioned database 260 shown in FIG. 2, with its partitions 262, 264, . . . , 266. There are corresponding database servers 430, 440, . . . . 450 for each of the database partitions. The application server 125 of the preferred embodiments includes a client-specified database server enlistment mechanism 128 and a database client 126 that includes a database server selection mechanism 127. The database client interacts with the database application 210. Note that items 125-128 in FIG. 4 are also present in FIG. 1, and are discussed above with reference to FIG. 1.

The goal of the preferred embodiments is to allow the database client to directly route database statements in a transaction to the correct database server, instead of having all database statements go through a single database server that has been enlisted for the transaction. The database client 126 determines which database server should process the transaction, then sends statements in the transaction directly to the correct database server. This may be done in different ways, as represented by the three illustrative embodiments described herein.

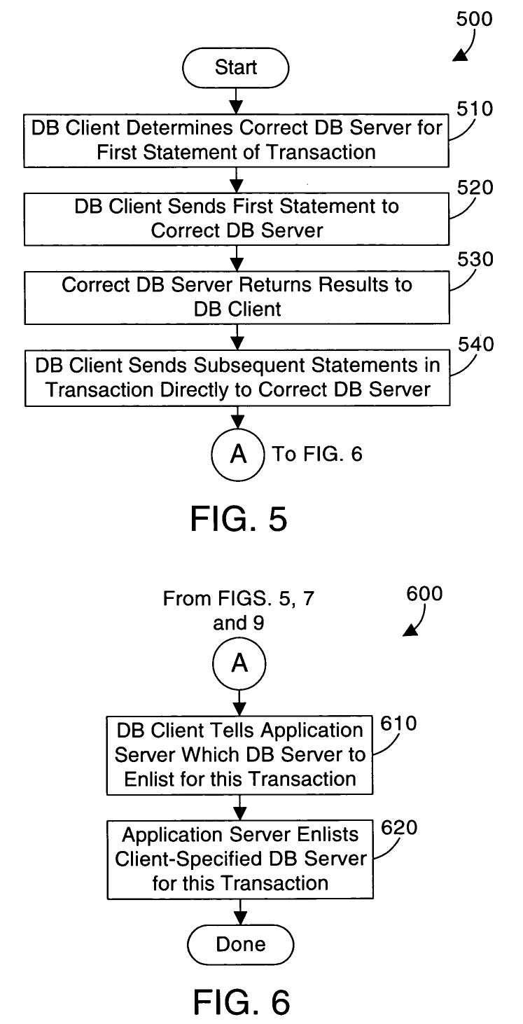

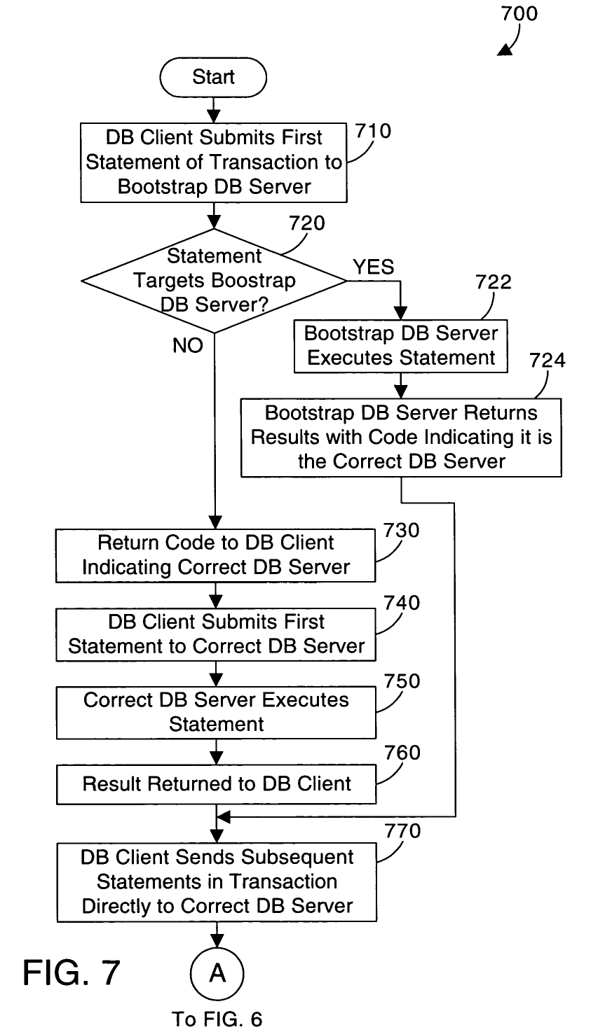

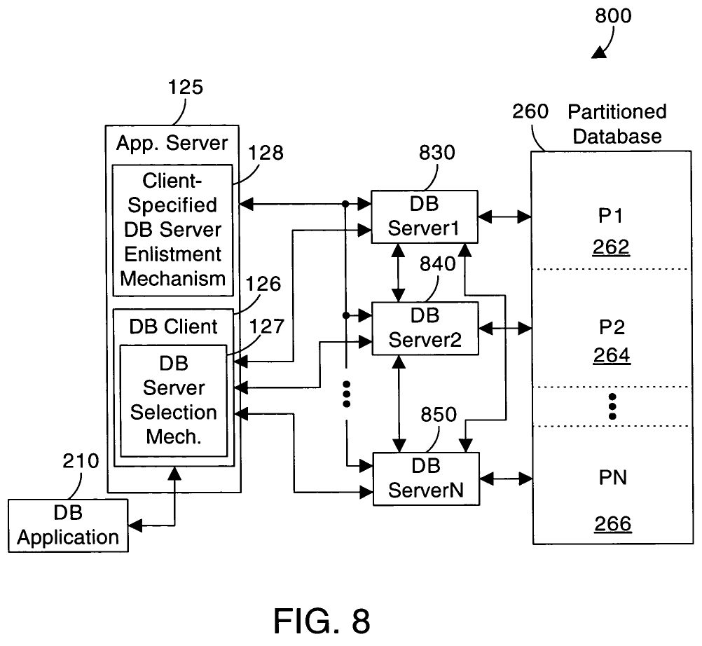

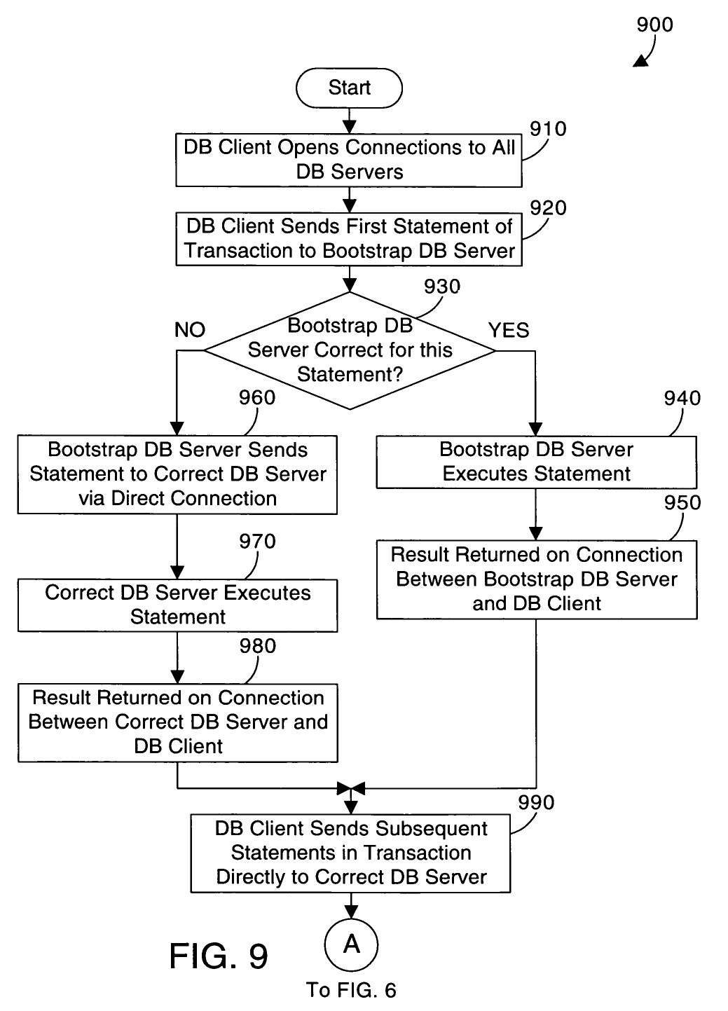

FIGS. 5 and 6 show steps that are performed in a method in accordance with the first and second embodiments. Referring to method 500 of FIG. 5, the database client determines the correct database server for the first statement of a transaction (step 510). The database client then sends the first statement to the correct database server (step 520). The correct database server returns the results to the database client (step 530). The database client then sends all subsequent statements in the transaction directly to the correct database server (step 540).

At this point the steps in method 600 in FIG. 6 may be performed. The database client tells the application server which database server to enlist for the transaction (step 610). The application server then enlists the client-specified database server for this transaction (step 620). Note that the steps in method 600 provide a function that is different than found in the prior art. In the prior art, the application server simply picks the bootstrap database server to enlist for the transaction, knowing that any database statement that targets a different database partition will be routed to the correct database server by the bootstrap database server. In the preferred embodiments, the application server waits until it is told by the database client which database server to enlist. The database client includes the intelligence to determine which database server is the correct database server, and can thus inform the application server which database server should be enlisted for the transaction. Note that the enlistment of the correct database server allows transaction recovery as is known in the art. The preferred embodiments thus provide two significant features that are not found in the art: 1) client-side routing of database requests to the correct database server; and 2) delayed client-directed enlistment of the correct database server to provide for transaction recovery.

There are different ways for the database client to determine the correct database server for the first statement of the transaction in step 510 of FIG. 5. One way in accordance with a first embodiment is to provide a map of database partitions and their corresponding database servers that is accessible to the database client. The database client could then look at the data accessed in a database statement, determine from the map which database partition is the target of the database statement, and thereby determine the corresponding database server for that database partition.

One specific implementation of method 500 in FIG. 5 in accordance with a second embodiment is shown as method 700 in FIG. 7. In this second embodiment, no map of static data is used to correlate database partitions to database servers. Instead, the correct database server may be determined dynamically. First, the database client submits the first statement of the transaction to a bootstrap database server (step 710). In the second embodiment, there are preferably multiple bootstrap database servers. This allows the system to continue to function, at least partially, if one of the bootstrap database servers goes down. Thus, for system 400 shown in FIG. 4, the database servers 430 and 440 could both be designated as “bootstrap servers”. A database statement in step 710 of FIG. 7 could be routed to either of the bootstrap servers. If the statement targets the bootstrap server that received the first statement in step 710 (step 720=YES), the bootstrap database server executes the statement (step 722) and returns the results with a code indicating it is the correct database server (step 724). If the statement does not target the bootstrap server that received the first statement in step 710 (step 720=NO), a code is returned to the database client that indicates the correct database server (step 730). In response, the database client submits the first statement in the transaction to the correct database server (step 740). The correct database server then executes the first statement (step 750). The result is then returned to the database client (step 760). The database client then sends all subsequent statements in the transaction directly to the correct database server (step 770). At this point, the steps of method 600 in FIG. 6 may be performed to cause the correct database server to be enlisted by the application server to provide for transaction recovery in the event of transaction failure.

In method 700 shown in FIG. 7, there is a performance penalty that is paid with the first statement in a transaction if the bootstrap server is not the correct server. However, this performance penalty only exists for the first statement in a transaction. All subsequent statements are routed directly to the correct server by the database client. Because transaction typically have many statements, the small performance penalty in executing the first statement is typically insignificant compared to the huge performance gains that result from sending all the remaining statements in the transaction directly to the correct server. As a result, method 700 provides a significant advancement in performance in a partitioned database system.

Referring now to FIG. 8, a database system 800 in accordance with a third embodiment provides the same partitioned database 260 and application server 125 with its associated client-specified database server enlistment mechanism 128, database client 126, and database server selection mechanism 127. What is different in FIG. 8 is the connections that exist between the database servers and the database client, and between the database servers themselves. Thus, database server 830 includes a connection to the application server 125, to the database client 126, and to the other database servers 840 and 850. In similar fashion, database server 840 includes a connection to the application server 125, to the database client 126, and to the other database servers 830 and 850. Database server 850 includes a connection to the application server 125, to the database client 126, and to the other database servers 830 and 840. With these many different connections, it is now possible to perform a method 900 in accordance with a third embodiment, shown in FIG. 9.

Method 900 begins by the database client opening connections to all database servers (step 910). The database client sends the first statement of a transaction to one of the bootstrap database servers (step 920). If the bootstrap database server that received the first statement is the correct database server for this first statement (step 930=YES), the bootstrap database server executes the statement (step 940), and the result is returned on the connection between the bootstrap database server and the database client (step 950). If the bootstrap database server that received the first statement is not the correct database server for this statement (step 930=NO), the bootstrap database server sends the statement to the correct database server via direct connection between the two (step 960). The correct database server then executes the statement (step 970), and returns the result to the database client on the connection between the correct database server and the database client (step 980). The database client then sends (or routes) all subsequent statements in the transaction directly to the correct database server for the transaction (step 990). At this point, the steps of method 600 in FIG. 6 may be performed to cause the correct database server to be enlisted by the application server to provide for transaction recovery in the event of transaction failure.

The embodiments disclosed herein assume that a transaction only accesses data in a single database partition. This assumption is valid for most commercial partitioned database systems. While a system administrator may want to perform some queries or statements that access multiple database partitions, or may want to include statements to multiple database partitions in the same transaction, these types of operations would likely be for troubleshooting or system administration only. The preferred embodiments provide a way to streamline the processing of transactions that are typically repeated a large number of times on data within a single database partition, thereby providing a significant increase in system performance.

Note that the term “database statement” is used herein to denote any type of statement that is capable of accessing a database, including SQL statements and queries. A database statement as used herein is one specific type of database request that may be processed in accordance with the preferred embodiments.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor;
a database residing in the memory, the database including a plurality of database partitions;
a plurality of database servers residing in the memory and executed by the at least one processor, each database server processing database requests for a corresponding database partition; and
a database client residing in the memory and executed by the at least one processor, the database client including a database server selection mechanism that determines which of the plurality of database servers is a correct database server to process a database transaction, the database client directing a plurality of database statements in the database transaction to the correct database server.

2. The apparatus of claim 1 wherein the database selection mechanism determines which of the plurality of database servers is the correct database server using a map that correlates each database partition to a corresponding database server.

3. The apparatus of claim 1 wherein the database selection mechanism determines which of the plurality of database servers is the correct database server by sending a first database request in the transaction to a selected database server, and by determining from a message received from the selected database server the correct database server.

4. The apparatus of claim 1 further comprising an application server residing in the memory and executed by the at least one processor, the application server including a client-specified database server enlistment mechanism that receives a message from the database client indicating which of the plurality of database servers is the correct database server, and in response thereto, the application server enlists the correct database server for the transaction.

5. The apparatus of claim 1 wherein the database transaction resides in an application program coupled to the database client.

6. An apparatus comprising:
at least one processor;
a memory coupled to the at least one processor;
a database residing in the memory, the database including a plurality of database partitions;
a plurality of database servers residing in the memory and executed by the at least one processor, each database server processing database requests for a corresponding one database partition;
a database client residing in the memory and executed by the at least one processor, the database client including a database server selection mechanism that determines which of the plurality of database servers is a correct database server to process a database transaction received from an application program, the database client directing a plurality of database statements in the database transaction to the correct database server; and
an application server residing in the memory and executed by the at least one processor, the application server including a client-specified database server enlistment mechanism that receives a message from the database client indicating which of the plurality of database servers is the correct database server, and in response thereto, the application server enlists the correct database server for the transaction, wherein the enlistment allows transaction recovery should the transaction fail.

7. The apparatus of claim 6 wherein the database selection mechanism determines which of the plurality of database servers is the correct database server using a map that correlates each database partition to a corresponding database server.

8. The apparatus of claim 6 wherein the database selection mechanism determines which of the plurality of database servers is the correct database server by sending a first database request in the transaction to a selected database server, and by determining from a message received from the selected database server the correct database server.

9. A method for a database client to process a database transaction to a database that includes a plurality of database partitions and a plurality of database servers corresponding to the plurality of database partitions, the method comprising the steps of:
(A) the database client determining which of the plurality of database servers is a correct database server to process the database transaction; and
(B) the database client directing a plurality of database statements in the database transaction to the correct database server.

10. The method of claim 9 wherein the database client determines which of the plurality of database servers is the correct database server using a map that correlates each database partition to a corresponding database server.

11. The method of claim 9 wherein the database client determines which of the plurality of database servers is the correct database server by sending a first database request in the transaction to a selected database server, and by determining from a message received from the selected database server the correct database server.

12. The method of claim 9 further comprising the steps of:
(C) the database client specifying to an application server which of the plurality of database servers is the correct database server; and
(D) in response to the specifying in (C), the application server enlists the correct database server for the transaction.

13. A method for a database client to process a database transaction to a database that includes a plurality of database partitions and a plurality of database servers corresponding to the plurality of database partitions, the method comprising the steps of:
(A) the database client determining which of the plurality of database servers is a correct database server to process the database transaction;
(B) the database client directing a plurality of database statements in the database transaction to the correct database server;
(C) the database client specifying to an application server which of the plurality of database servers is the correct database server; and
(D) in response to the specifying in (C), the application server enlists the correct database server for the transaction, wherein the enlistment allows transaction recovery should the transaction fail.

14. The method of claim 13 wherein the database client determines which of the plurality of database servers is the correct database server using a map that correlates each database partition to a corresponding database server.

15. The method of claim 13 wherein the database client determines which of the plurality of database servers is the correct database server by sending a first database request in the transaction to a selected database server, and by determining from a message received from the selected database server the correct database server.

16. A program product comprising:
a database client that includes a database server selection mechanism that determines which of a plurality of database servers that each process database requests for a corresponding database partition is a correct database server to process a database transaction to a database that includes a plurality of database partitions, the database client directing a plurality of database statements in the database transaction to the correct database server; and
signal bearing media bearing the database client.

17. The program product of claim 16 wherein the signal bearing media comprises recordable media.

18. The program product of claim 16 wherein the signal bearing media comprises transmission media.

19. The program product of claim 16 wherein the database selection mechanism determines which of the plurality of database servers is the correct database server using a map that correlates each database partition to a corresponding database server.

20. The program product of claim 16 wherein the database selection mechanism determines which of the plurality of database servers is the correct database server by sending a first database request in the transaction to a selected database server, and by determining from a message received from the selected database server the correct database server.

21. The program product of claim 16 further comprising an application server that includes a client-specified database server enlistment mechanism that receives a message from the database client indicating which of the plurality of database servers is the correct database server, and in response thereto, the application server enlists the correct database server for the transaction.

22. The program product of claim 16 wherein the database transaction resides in an application program coupled to the database client.

23. A program product comprising:
(1) a database client that includes a database server selection mechanism that determines which of a plurality of database servers that each process database requests for a corresponding one database partition is a correct database server to process a database transaction to a database that includes a plurality of database partitions, the database client directing a plurality of database statements in the database transaction to the correct database server;
(2) an application server that includes a client-specified database server enlistment mechanism that receives a message from the database client indicating which of the plurality of database servers is the correct database server, and in response thereto, the application server enlists the correct database server for the transaction, wherein the enlistment allows transaction recovery should the transaction fail; and
(3) signal bearing media bearing the database client and the application server.

24. The program product of claim 23 wherein the signal bearing media comprises recordable media.

25. The program product of claim 23 wherein the signal bearing media comprises transmission media.

26. The program product of claim 23 wherein the database selection mechanism determines which of the plurality of database servers is the correct database server using a map that correlates each database partition to a corresponding database server.

27. The program product of claim 23 wherein the database selection mechanism determines which of the plurality of database servers is the correct database server by sending a first database request in the transaction to a selected database server, and by determining from a message received from the selected database server the correct database server.
